(19) United States
(12) Patent Application Publication
(10) Pub. No.: US 2026/0170184 A1
(43) Pub. Date: Jun. 18, 2026

(54) SENDING REPLAY PROTECTED MONOTONIC COUNTER COMMANDS TO A MEMORY DEVICE

(71) Applicant: QUALCOMM Incorporated, San Diego, CA (US)

(72) Inventors: Snigdha CHALASANI, San Diego, CA (US); William KIMBERLY, San Diego, CA (US)

(21) Appl. No.: 18/980,235

(22) Filed: Dec. 13, 2024

(51) Int. Cl. G06F 21/79; G06F 21/64

(52) U.S. Cl. CPC G06F 21/79; G06F 21/64

(57) ABSTRACT

Various aspects of the present disclosure generally relate to memory systems. In some aspects, a controller may send, to a memory device, a replay protected monotonic counter (RPMC) command associated with a hardware attack protection, wherein the RPMC command is one of: a write root key register command, an update hash-based message authentication code (HMAC) key register command, a request monotonic counter (MC) command, or an increment MC command. The controller may send, to the memory device, a read data command based at least in part on the write root key register command, the update HMAC key register command, the request MC command, or the increment MC command. Numerous other aspects are described.

### FIELD OF THE DISCLOSURE

Aspects of the present disclosure generally relate to memory systems and specifically, to techniques and apparatuses for sending replay protected monotonic counter commands to a memory device.

### BACKGROUND

A non-volatile memory device, such as a flash memory device, may use circuitry to retain stored information even after a power is removed. Non-volatile memory devices may be used in various types of electronic devices, such as computers, mobile phones, or automobile computing systems, among other examples.

### SUMMARY

In some implementations, a controller includes one or more components configured to: send, to a memory device, a replay protected monotonic counter (RPMC) command associated with a hardware attack protection, wherein the RPMC command is one of: a write root key register command, an update hash-based message authentication code (HMAC) key register command, a request monotonic counter (MC) command, or an increment MC command; and send, to the memory device, a read data command based at least in part on the write root key register command, the update HMAC key register command, the request MC command, or the increment MC command.

In some implementations, a memory device includes one or more components configured to: receive, from a controller, an RPMC command associated with a hardware attack protection, wherein the RPMC command is one of: a write root key register command, an update HMAC key register command, a request MC command, or an increment MC command; and receive, from the controller, a read data command based at least in part on the write root key register command, the update HMAC key register command, the request MC command, or the increment MC command.

In some implementations, a method includes sending, by a controller to a memory device, an RPMC command associated with a hardware attack protection, wherein the RPMC command is one of: a write root key register command, an update HMAC key register command, a request MC command, or an increment MC command; and sending, by the controller to the memory device, a read data command based at least in part on the write root key register command, the update HMAC key register command, the request MC command, or the increment MC command.

In some implementations, a method includes receiving, by a memory device from a controller, an RPMC command associated with a hardware attack protection, wherein the RPMC command is one of: a write root key register command, an update HMAC key register command, a request MC command, or an increment MC command; and receiving, by the memory device from the controller, a read data command based at least in part on the write root key register command, the update HMAC key register command, the request MC command, or the increment MC command.

In some implementations, an apparatus comprises: means for sending, by a controller to a memory device, an RPMC command associated with a hardware attack protection, wherein the RPMC command is one of: a write root key register command, an update HMAC key register command, a request MC command, or an increment MC command; and means for sending, by the controller to the memory device, a read data command based at least in part on the write root key register command, the update HMAC key register command, the request MC command, or the increment MC command.

In some implementations, an apparatus comprises: means for receiving, by a memory device from a controller, an RPMC command associated with a hardware attack protection, wherein the RPMC command is one of: a write root key register command, an update HMAC key register command, a request MC command, or an increment MC command; and means for receiving, by the memory device from the controller, a read data command based at least in part on the write root key register command, the update HMAC key register command, the request MC command, or the increment MC command.

Aspects generally include a method, apparatus, system, computer program product, non-transitory computer-readable medium, memory device, or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example associated with an approach for sending replay protected monotonic counter (RPMC) commands.

FIG. 2 is a diagram illustrating an example associated with an approach for sending RPMC commands.

FIG. 3 is a diagram illustrating an example associated with sending RPMC commands, in accordance with the present disclosure.

FIG. 4 is a diagram illustrating an example associated with sending RPMC commands, in accordance with the present disclosure.

FIG. 5 is a diagram illustrating an example associated with sending RPMC commands, in accordance with the present disclosure.

FIG. 6 is a flowchart of an example method associated with sending RPMC commands.

### DETAILED DESCRIPTION

A controller, such as a serial flash controller, may send various types of commands to a memory device, such as a serial flash device. The commands may be replay protected monotonic counter (RPMC) commands. The RPMC commands may include a write root key register command, an update hash-based message authentication code (HMAC) key register command, a request monotonic counter (MC) command, an increment MC command, and/or a read data command.

The RPMC commands may be associated with an increased security risk, where the increased security risk may be due to a potential hardware attack. The potential hardware attack may be from an attacker that has physical access to the controller and/or the memory device. For example, the write root key register command and the increment MC command may not be associated with any number used once (nonce), which may increase the security risk associated with the write root key register command and the increment MC command. As another example, for the read data command, an extended status may not be used when computing a signature, which may increase the security risk. For the read data command, the signature may be computed using only a tag and a counter data and not the extended status, which may increase the security risk associated with the read data command. As another example, for the read data command, the tag, the counter data, and the signature may not be authenticated when the read data command is sent in response to the write root key register command, the update HMAC key register command, or the increment MC command. For the read data command, the tag, the counter data, and the signature may only be valid (authenticated) when the read data command is sent in response to the request MC command. As a result, the security risk associated with the write root key register command, the update HMAC key register command, and the increment MC command may be increased. The write root key register command, the update HMAC key register command, and the increment MC command (e.g., non-request-MC commands) may not be associated with any form of authentication, which may increase a possibility of the attacker interrupting the read data command for the write root key register command, the update HMAC key register command, or the increment MC command, and sending false responses.

In one example, to overcome the increased security risk, the request MC command may be executed along with the increment MC command to ensure that an MC is being incremented as expected. In other words, both the request MC command and the increment MC command may be sent in a near simultaneous manner, which may indicate that the increment MC command is not likely to be associated with an attack. Sending both the request MC command and the increment MC command may lead to an execution time of the increment MC command increasing by up to 105 microseconds (μs), which may degrade an overall system performance.

Various aspects relate generally to sending RPMC commands. In some aspects, a controller may send, to a memory device, an RPMC command associated with a hardware attack protection. The controller may be a serial flash controller and the memory device may be a serial flash device. The controller and the memory device may be in accordance with a Joint Electron Device Engineering Council (JEDEC) memory standard. The JEDEC memory standard may be promulgated by a JEDEC Solid State Technology Association. The RPMC command may be a write root key register command, an update HMAC key register command, a request MC command, or an increment MC command. The controller may send, to the memory device, a read data command based at least in part on the write root key register command, the update HMAC key register command, the request MC command, or the increment MC command.

In some aspects, the read data command may indicate an extended status, a tag, counter data, and a signature. The signature may be computed based at least in part on the extended status, the tag, and the counter data. The extended status may be authenticated in the read data command based at least in part on an HMAC message for the signature. The HMAC message for the signature may be based at least in part on the extended status, the tag, and the counter data. In this example, the controller may authenticate the extended status in the read data command.

In some aspects, the write root key register command may indicate a command type, a counter address, a reserved byte, a nonce, a root key, and a signature. The increment MC command may indicate a command type, a counter address, a reserved byte, a nonce, counter data, and a signature. In this example, the controller may implement a nonce in every RPMC command that is sent to the memory device.

In some aspects, the read data command may be in response to the write root key register command. The read data command may indicate an extended status, key data, and a signature. In some aspects, the read data command may be in response to the update HMAC key register command. The read data command may indicate an extended status, a nonce, and a signature. In some aspects, the read data command may be in response to the increment MC command. In these examples, the controller may add one or more fields to the read data command, where the one or more fields may be associated with an authentication.

Particular aspects of the subject matter described in this disclosure can be implemented to realize one or more of the following potential advantages. In some examples, by authenticating the extended status in the read data command, implementing the nonce in every RPMC command that is sent to the memory device, and/or adding the one or more fields associated with the authentication, the controller and/or the memory device may be associated with a decreased boot time, an enhanced security and integrity of operations, a reduced risk of denial-of-service attacks, and/or an increased prevention of false failures and successes. For example, by employing added security to the increment MC command, the increment MC command may not need to be sent with the request MC command, which may decrease an execution time. As a result, authenticating the extended status in the read data command, implementing the nonce in every RPMC command that is sent to the memory device, and/or adding the one or more fields associated with the authentication may improve an overall system performance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented, or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

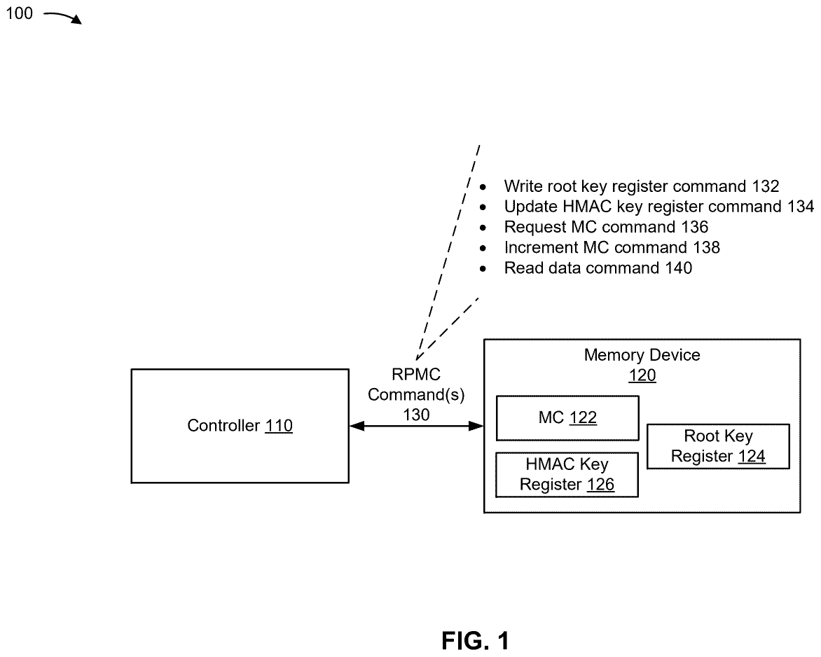

FIG. 1 is a diagram illustrating an example 100 associated with an approach for sending RPMC commands. The example 100 may include a controller 110 and a memory device 120. The controller 110 may be a system-on-chip (SoC) controller, a host controller, or a memory controller. In one example, the controller 110 may be a flash memory controller, such as a serial flash controller. The memory device 120 may be a non-volatile memory device, such as a serial flash device. The controller 110 may communicate with the memory device 120 via an interface. The controller 110 and the memory device 120 may be associated with a computer, a mobile phone, a wired or wireless communication device, a network device, a server, a device in a data center, a device in a cloud computing environment, a vehicle (e.g., an automobile or an airplane), and/or an Internet of Things (IoT) device. The controller 110 and the memory device 120 may be in accordance with a JEDEC standard.

The memory device 120 may include an MC 122, such as an RPMC. The MC 122 may provide additional security for replay protection. The MC 122 may be a counter value that is stored in the memory device 120. The MC 122 may be guaranteed to only increase (monotonic). The MC 122 may be a unique and incrementing counter used for security purposes to prevent replay attacks. The MC 122 may include the replay protection to prevent an attacker from tampering with or reusing previous values (old data) to gain unauthorized access. In one example, each time a specific operation is executed, the MC 122 may be incremented, and an updated counter value may be written to the memory device 120. The MC 122 may be used for preventing rollbacks, tracking transactions, blocking replay attacks, validating firmware updates, and/or authenticating data. The memory device 120 may also include a root key register 124 and an HMAC key register 126.

The controller 110 may send various types of RPMC commands 130 to the memory device 120. The RPMC commands 130 may include a write root key register command 132, an update HMAC key register command 134, a request MC command 136, an increment MC command 138, and/or a read data command 140. The write root key register command 132, the update HMAC key register command 134, the request MC command 136, and the increment MC command 138 may each be associated with the read data command 140.

The write root key register command 132 may be used by the controller 110 to initialize the root key register 124, which may correspond to a counter address with a root key. The counter address that is indicated in the write root key register command 132 may also be referred to as a received counter address or a requested counter address. The counter address may refer to a specific memory location within the memory device 120 at which the counter value associated with the MC 122 is stored. The counter address may allow the memory device 120 to read and update the MC 122. The root key may be a received root key. The write root key register command 132 may be used in an original equipment manufacturer (OEM) environment when the controller 110 and the memory device 120 are powered together for a first time. In other words, the write root key register command 132 may be associated with an OEM manufacturing mode. After the write root key register command 132 is issued by the controller 110 on the interface between the controller 110 and the memory device 120, the memory device 120 may ensure that the write root key register command 132 (e.g., a received transaction) is error free. For example, the memory device 120 may check whether a payload size is correct, whether the counter address falls within a range of supported counters, whether the root key register 124 corresponding to the requested counter address was previously uninitialized, and/or whether a truncated signature field is a same as a least significant 224 bits of an HMAC Secure Hash Algorithm (SHA) 256 (HMAC-SHA256) based signature that is computed based at least in part on received input parameters. “HMAC” may refer to a specific construction for calculating a message authentication code (MAC) involving a cryptographic hash function in combination with a secret 256 bit encryption key. When the write root key register command 132 is error free, the memory device 120 may successfully execute the write root key register command 132 and post a successful completion extended status. When the write root key register command 132 is executed, the root key may be stored inside the memory device 120. The root key may not be readable from outside of the memory device 120. The root key may be a 256-bit root key. When the write root key register command 132 has one or more errors, the memory device 120 may not execute the write root key register command 132, and may post a corresponding error in an extended status. The extended status may be 8 bits.

The update HMAC key register command 134 may be used by the controller 110 to update the HMAC key register 126, which may correspond to a counter address with a new HMAC key calculated based at least in part on a received input. The counter address may be a received or requested counter address. The update HMAC key register command 134 may be issued on every power cycle event or deep sleep mode exit over the interface between the controller 110 and the memory device 120. The update HMAC key register command 134 may allow HMAC key storage to be implemented using volatile memory. After the update HMAC key register command 134 is issued by the controller 110 on the interface between the controller 110 and the memory device 120, the memory device 120 may ensure that the update HMAC key register command 134 (e.g., a received transaction) is error free. For example, the memory device 120 may check whether a payload size is correct, whether the counter address falls within a range of supported counters, whether an MC corresponding to the requested counter address was previously initialized, and/or whether a signature matches an HMAC-SHA256 based signature that is computed based at least in part on received input parameters. When the update HMAC key register command 134 is error free, the memory device 120 may successfully execute the update HMAC key register command 134 and post a successful completion extended status. When the update HMAC key register command 134 has one or more errors, the memory device 120 may not execute the update HMAC key register command 134, and may post a corresponding error in an extended status. The extended status may be 8 bits.

The request MC command 136 may be used by the controller 110 to request an MC value inside of the memory device 120. The MC value may be associated with the MC 122 employed by the memory device 120. The request MC command 136 may indicate a counter address. The counter address may be a requested counter address. After the request MC command 136 is issued by the controller 110 on the interface between the controller 110 and the memory device 120, the memory device 120 may ensure that the request MC command 136 (e.g., a received transaction) is error free. For example, the memory device 120 may check whether a payload size is correct, whether the counter address falls within a range of supported counters, whether the MC 122 corresponding to the requested counter address was previously initialized, whether the HMAC key register 126 corresponding to the requested counter address was previously initialized, and/or whether a requested signature matches an HMAC-SHA256 based signature that is computed based at least in part on received input parameters. When the request MC command 136 is error free, the memory device 120 may successfully execute the request MC command 136 and post a successful completion extended status. The memory device 120 may read the MC 122 addressed by the counter address. When the request MC command 136 has one or more errors, the memory device 120 may not execute the request MC command 136, and may post a corresponding error in an extended status. The extended status may be 8 bits.

The increment MC command 138 may be used by the controller 110 to increment the MC 122 associated with the memory device 120 by one. The increment MC command 138 may indicate a counter address. The counter address may be a requested counter address. After the increment MC command 138 is issued by the controller 110 on the interface between the controller 110 and the memory device 120, the memory device 120 may ensure that the increment MC command 138 (e.g., a received transaction) is error free. For example, the memory device 120 may check whether a payload size is correct, whether the counter address falls within a range of supported counters, whether the MC 122 corresponding to the requested counter address was previously initialized, whether the HMAC key register 126 corresponding to the requested counter address was previously initialized, and/or whether a requested signature matches an HMAC-SHA256 based signature that is computed based at least in part on received input parameters. When the increment MC command 138 is error free, the memory device 120 may successfully execute the increment MC command 138 and post a successful completion extended status. When the increment MC command 138 has one or more errors, the memory device 120 may not execute the increment MC command 138, and may post a corresponding error in an extended status. The extended status may be 8 bits.

The read data command 140 may be used by the controller 110 to read an extended status from any previously issued command, such as a previously issued operation (OP) command. The previously issued command may include the write root key register command 132, the update HMAC key register command 134, the request MC command 136, and/or the increment MC command 138. The extended status may indicate whether or not the previously issued command was successful. When the previously issued command is the request MC command 136 and when the memory device 120 returns a successful completion extended status, the read data command 140 may return valid values in the tag, counter data, and signature fields. Otherwise, values returned in the tag, counter data, and signature fields may be invalid.

The memory device 120 may store basic input/output system (BIOS) code and critical configuration settings pertaining to certain functionalities, such as power management. The memory device 120 may partition and/or store secure keys and certificates. However, the memory device 120 may not offer sufficient protection against hardware attacks, where the attacker has physical access to the memory device 120. The attacker may be able to modify data stored in the memory device 120 (e.g., flash content) by de-soldering a component of the memory device 120 and then reprogramming or replacing the component. The attacker may be able to capture information by probing the information using a logic analyzer and replaying the information at a different time. The attacker may be able to modify the data stored in the memory device 120 on-the-fly by inserting a field-programmable gate array (FPGA) between the controller 110 and the memory device 120.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

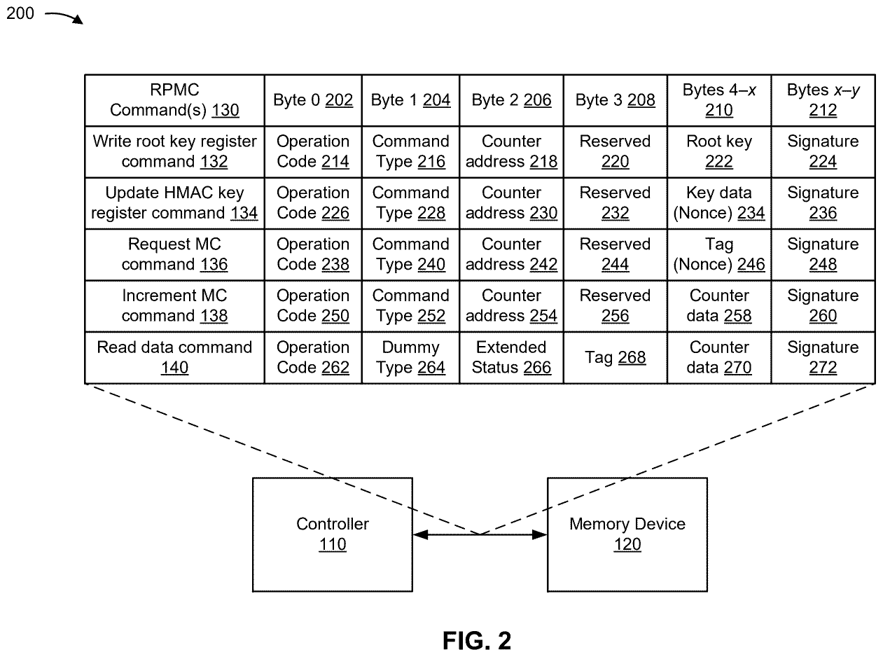

FIG. 2 is a diagram illustrating an example 200 associated with an approach for sending RPMC commands. The example 200 may include a controller 110 and a memory device 120. The controller 110 may be an SoC controller, a host controller, or a memory controller. In one example, the controller 110 may be a flash memory controller, such as a serial flash controller. The memory device 120 may be a non-volatile memory device, such as a serial flash device. The controller 110 may communicate with the memory device 120 via an interface. The controller 110 and the memory device 120 may be in accordance with a JEDEC standard.

The controller 110 may send various types of RPMC commands 130 to the memory device 120. The RPMC commands 130 may include a write root key register command 132, an update HMAC key register command 134, a request MC command 136, an increment MC command 138, and/or a read data command 140. Each RPMC command 130 may be associated with byte 0 202, byte 1 204, byte 2 206, byte 3 208, bytes 4-x 210, and bytes x-y 212, where x and y are positive integers. The write root key register command 132, the update HMAC key register command 134, the request MC command 136, and the increment MC command 138 may be associated with a payload. The read data command 140 may be associated with a response.

In the write root key register command 132, byte 0 202 may indicate an operation code 214 (e.g., 0×9B), byte 1 204 may indicate a command type 216 (e.g., 0×0), byte 2 206 may indicate a counter address 218, byte 3 208 may be a reserved byte 220, bytes 4-x 210 may indicate a root key 222, and bytes x-y 212 may indicate a signature 224. In the update HMAC key register command 134, byte 0 202 may indicate an operation code 226 (e.g., 0×9B), byte 1 204 may indicate a command type 228 (e.g., 0×1), byte 2 206 may indicate a counter address 230, byte 3 208 may be a reserved byte 232, bytes 4-x 210 may indicate key data (nonce) 234, and byte x to y 212 may indicate a signature 236. In the request MC command 136, byte 0 202 may indicate an operation code 238 (e.g., 0×9B), byte 1 204 may indicate a command type 240 (e.g., 0×2), byte 2 206 may indicate a counter address 242, byte 3 208 may be a reserved byte 244, bytes 4-x 210 may indicate a tag (nonce) 246, and bytes x-y 212 may indicate a signature 248. In the increment MC command 138, byte 0 202 may indicate an operation code 250 (e.g., 0×9B), byte 1 204 may indicate a command type 252 (e.g., 0×3), byte 2 206 may indicate a counter address 254, byte 3 208 may be a reserved byte 256, bytes 4-x 210 may indicate counter data 258, and bytes x-y 212 may indicate a signature 260. In the read data command 140, byte 0 202 may indicate an operation code 262 (e.g., 0×96), byte 1 204 may indicate a dummy type 264, byte 2 206 may indicate an extended status 266, byte 3 208 may indicate a tag 268, bytes 4-x 210 may indicate counter data 270, and bytes x-y 212 may indicate a signature 272.

The RPMC commands 130 may be associated with an increased security risk, where the increased security risk may be due to a potential hardware attack. The potential hardware attack may be from an attacker that has physical access to the controller 110 and/or the memory device 120. For example, the write root key register command 132 and the increment MC command 138 may not be associated with any nonce, which may increase the security risk associated with the write root key register command 132 and the increment MC command 138. A nonce may be a generic random value or pseudo-random number that is only used once in a communication to keep the communication secure and private. As another example, the extended status 266 may not be used when computing the signature 272, which may increase the security risk. The signature 272 may be computed using only the tag 268 and the counter data 270 and not the extended status 266, which may increase the security risk associated with the read data command 140. As another example, for the read data command 140, the tag 268, the counter data 270, and the signature 272 may not be authenticated when the read data command 140 is sent in response to the write root key register command 132, the update HMAC key register command 134, or the increment MC command 138. For the read data command 140, the tag 268, the counter data 270, and the signature 272 may only be valid (authenticated) when the read data command 140 is sent in response to the request MC command 136. As a result, the security risk associated with the write root key register command 132, the update HMAC key register command 134, and the increment MC command 138 may be increased. The write root key register command 132, the update HMAC key register command 134, and the increment MC command 138 (e.g., non-request-MC commands) may not be associated with any form of authentication, which may increase a possibility of the attacker interrupting the read data command 140 for the write root key register command 132, the update HMAC key register command 134, or the increment MC command 138, and sending false responses.

In one example, to overcome the increased security risk, the request MC command 136 may be executed along with the increment MC command 138 to ensure that an MC is being incremented as expected. In other words, both the request MC command 136 and the increment MC command 138 may be sent in a near simultaneous manner, which may indicate that the increment MC command 138 is not likely to be associated with an attack. Sending both the request MC command 136 and the increment MC command 138 may lead to an execution time of the increment MC command 138 increasing by a substantial amount (e.g., up to 105 μs), which may degrade an overall system performance.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

In some aspects, a controller (e.g., controller 110) may send one or more commands to a memory device (e.g., memory device 120). The commands may include RPMC commands. The commands may include a write root key register command, an update HMAC key register command, a request MC command, an increment MC command, and/or a read data command. In some aspects, the controller may authenticate an extended status in the read data command. In some aspects, the controller may implement a nonce in every RPMC command that is sent to the memory device. In some aspects, the controller may add one or more fields to the read data command, where the one or more fields may be associated with an authentication.

In some aspects, by authenticating the extended status in the read data command, implementing the nonce in every RPMC command that is sent to the memory device, and/or adding the one or more fields associated with the authentication, the controller and/or the memory device may be associated with a decreased boot time, an enhanced security and integrity of operations, a reduced risk of denial-of-service attacks, and/or an increased prevention of false failures and successes. As a result, authenticating the extended status in the read data command, implementing the nonce in every RPMC command that is sent to the memory device, and/or adding the one or more fields associated with the authentication may improve an overall system performance.

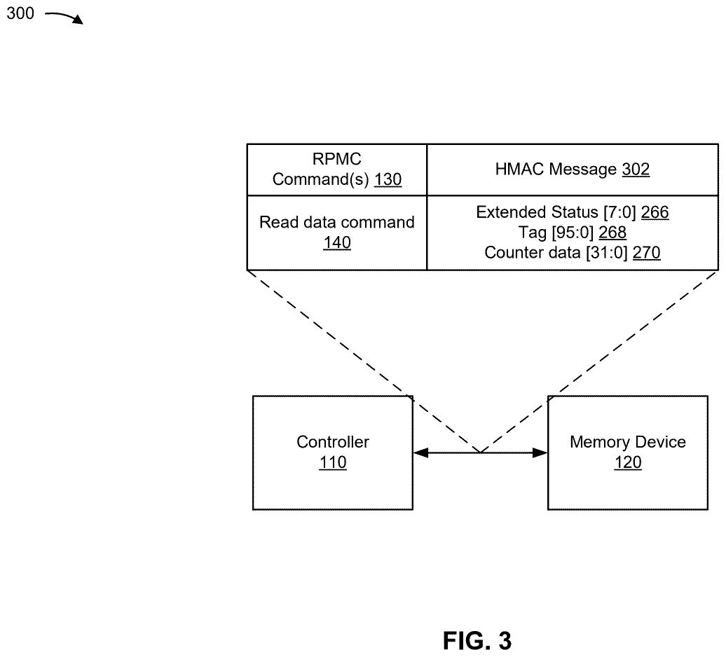

FIG. 3 is a diagram illustrating an example 300 associated with sending RPMC commands, in accordance with the present disclosure. The example 300 may include a controller 110 and a memory device 120. The controller 110 may be an SoC controller, a host controller, or a memory controller. In one example, the controller 110 may be a flash memory controller, such as a serial flash controller. The memory device 120 may be a non-volatile memory device, such as a serial flash device. The controller 110 may communicate with the memory device 120 via an interface. The controller 110 and the memory device 120 may be in accordance with a JEDEC standard.

As shown in FIG. 3, the controller 110 may transmit various types of RPMC commands 130 to the memory device 120, where the various types of RPMC commands 130 may include a read data command 140. The read data command 140 may indicate an extended status 266, a tag 268, and counter data 270. The read data command 140 may be associated with a request MC command (e.g., request MC command 136, as shown in FIG. 1). The read data command 140 may indicate an HMAC message 302. The HMAC message 302, along with an HMAC key, may be included in a signature (e.g., signature 272). The HMAC message 302 may be based at least in part on the extended status 266, the tag 268, and the counter data 270. Within the HMAC message 302, the extended status 266 may be associated with 1 byte (e.g., bit 0 to bit 7), the tag 268 may be associated with 12 bytes (e.g., bit 0 to bit 95), and the counter data 270 may be associated with 4 bytes (e.g., bit 0 to bit 31). In other words, the HMAC message 302 may be computed using the extended status 266, the tag 268, and the counter data 270. The extended status 266 may be authenticated in the read data command 140 based at least in part on the HMAC message 302.

In an alternative approach, a signature for a read data command may only be based on a tag and counter data. Within the signature, the tag would be associated with 12 bytes (e.g., bit 0 to bit 95), and the counter data would be associated with 4 bytes (e.g., bit 0 to bit 31). In the alternative approach, for the read data command, the signature would only be computed for the tag and the counter data. The signature would not be computed based at least in part on an extended status. As a result, with the alternative approach, an attacker would be able to send a bad response to a request, which would render device data unreliable. The attacker would be able to send a good response to a bad command, which would lead to unexpected device functions. The attacker would be able to report false failures and/or false successes, which would cause a non-functionality during a device power up.

In some aspects, the HMAC message 302 may include the extended status 266 as part of an authentication, which may ensure that the extended status 266 is not tampered with by the attacker. The authentication may be added for the extended status 266, which may aid with a correct recognition of a response and a validity of a command. By incorporating the extended status 266 into the HMAC message 302, the attacker may not be able to send a bad response to a request rendering device data unreliable, the attacker may not be able to send a good response to a bad command leading to unexpected device functions, and/or the attacker may not be able to report false failures and successes leading to device non-functionality during a power up.

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

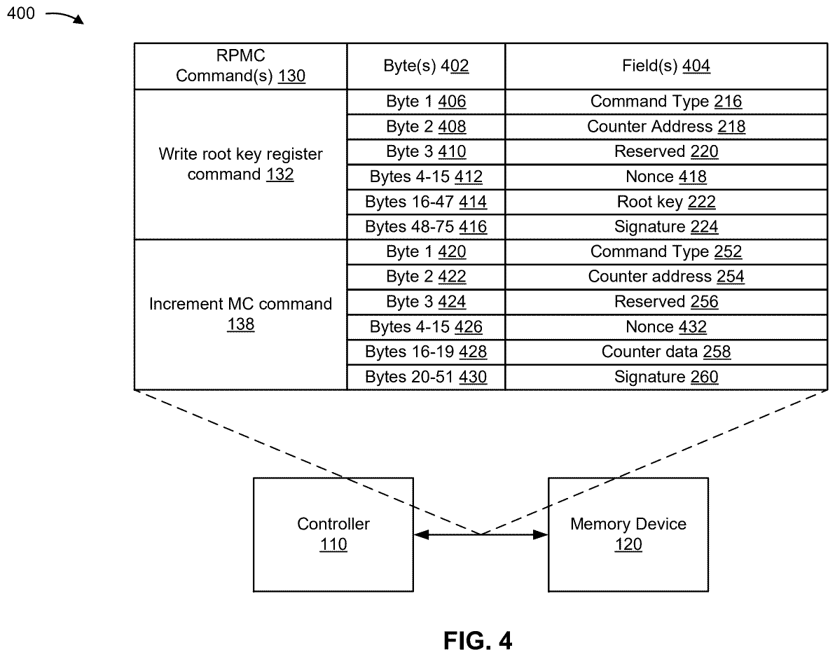

FIG. 4 is a diagram illustrating an example 400 associated with sending RPMC commands, in accordance with the present disclosure. The example 400 may include a controller 110 and a memory device 120. The controller 110 may be an SoC controller, a host controller, or a memory controller. In one example, the controller 110 may be a flash memory controller, such as a serial flash controller. The memory device 120 may be a non-volatile memory device, such as a serial flash device. The controller 110 may communicate with the memory device 120 via an interface. The controller 110 and the memory device 120 may be in accordance with a JEDEC standard.

As shown in FIG. 4, the controller 110 may transmit various types of RPMC commands 130 to the memory device 120, where the various types of RPMC commands 130 may include a write root key register command 132 and an increment MC command 138. Each RPMC command 130 may include a plurality of bytes 402 and a plurality of fields 404, where one or more bytes 402 may be associated with a given field 404. In the write root key register command 132, byte 1 406 may indicate a command type 216, byte 2 408 may indicate a counter address 218, byte 3 410 may be a reserved byte 220, bytes 4-15 412 may indicate a nonce 418, bytes 16-47 414 may indicate a root key 222, and bytes 48-75 416 may indicate a signature 224. In the increment MC command 138, byte 1 420 may indicate a command type 252, byte 2 422 may indicate a counter address 254, byte 3 424 may be a reserved byte 256, bytes 4-15 426 may indicate a nonce 432, bytes 16-19 428 may indicate counter data 258, and bytes 20-51 430 may indicate a signature 260. In these examples, the write root key register command 132 may indicate the command type 216, the counter address 218, the reserved byte 220, the nonce 418, the root key 222, and the signature 224, and the increment MC command 138 may indicate the command type 252, the counter address 254, the reserved byte 256, the nonce 432, the counter data 258, and the signature 260.

In an alternative approach, in a write root key register command, byte 1 would indicate a command type, byte 2 would indicate a counter address, byte 3 would be reserved, bytes 4-35 would indicate a root key, and bytes 36-63 would indicate a signature. The write root key register command would not indicate any nonce. In the alternative approach, in an increment MC command, byte 1 would indicate a command type, byte 2 would indicate a counter address, byte 3 would be reserved, bytes 4-7 would indicate counter data, and bytes 8-39 would indicate a signature. The increment MC command would not indicate any nonce.

In some aspects, the RPMC commands 130 may each implement a nonce. For example, the write root key register command 132 may indicate the nonce 418, and the increment MC command 138 may indicate the nonce 432. Adding the nonce to every RPMC command 130 may improve security because the nonce may add an element of variability and may aid in achieving a robust authentication for each RPMC command 130. The RPMC commands 130 may each implement the nonce to prevent denial-of-service attacks. For example, when the nonce is not incorporated, an attacker may carry out an attack by sending a false response to a command. By incorporating the nonce into the RPMC commands 130, the attack may not be successful. When the nonce is incorporated for each command and transaction, the transaction may need to be authenticated and the transaction may be discarded when the nonce is not validated. As another example, when the nonce is not incorporated and an attack is launched, a memory device may become non-functional during a power up because a controller (e.g., an SoC) may not continuously receive an expected response from the memory device. By incorporating the nonce into the RPMC commands 130, the controller may be able to continuously receive an expected response from the memory device, which may allow the memory device to be functional during the power up.

As indicated above, FIG. 4 is provided as an example. Other examples may differ from what is described with regard to FIG. 4. The number and arrangement of devices shown in FIG. 4 are provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) shown in FIG. 4 may perform one or more functions described as being performed by another set of devices shown in FIG. 4.

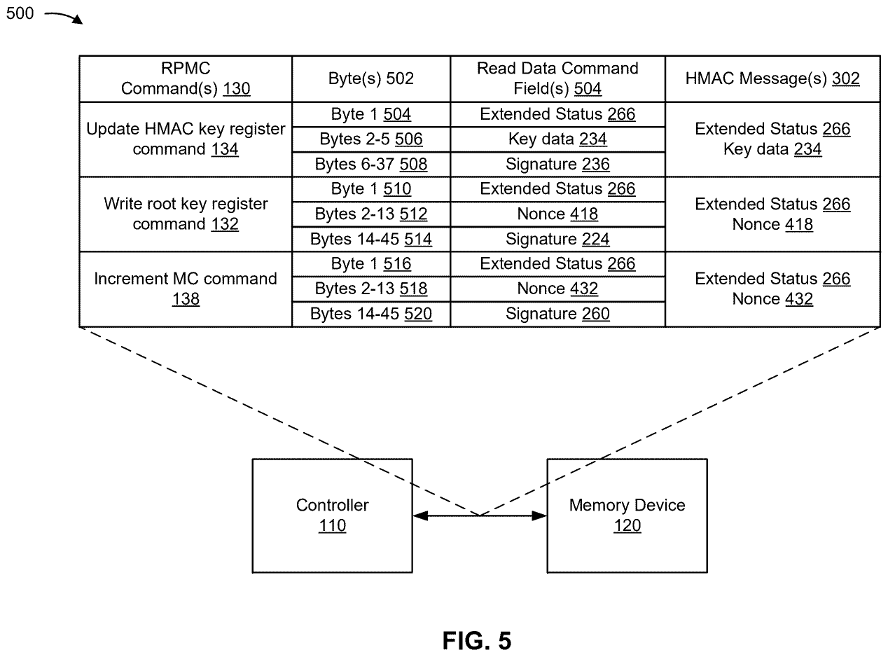

FIG. 5 is a diagram illustrating an example 500 associated with sending RPMC commands, in accordance with the present disclosure. The example 500 may include a controller 110 and a memory device 120. The controller 110 may be an SoC controller, a host controller, or a memory controller. In one example, the controller 110 may be a flash memory controller, such as a serial flash controller. The memory device 120 may be a non-volatile memory device, such as a serial flash device. The controller 110 may communicate with the memory device 120 via an interface. The controller 110 and the memory device 120 may be in accordance with a JEDEC standard.

As shown in FIG. 5, the controller 110 may transmit various types of RPMC commands 130 to the memory device 120, where the various types of RPMC commands 130 may include an update HMAC key register command 134, a write root key register command 132, and an increment MC command 138. For each of the update HMAC key register command 134, the write root key register command 132, and the increment MC command 138, the controller 110 may transmit a respective read data command (e.g., read data command 140, as shown in FIG. 1), where each read data command may include a plurality of bytes 502 and a plurality of read data command fields 504. The plurality of read data command fields 504 may be associated with a plurality of HMAC messages 302, respectively.

In some aspects, for a read data command in response to the update HMAC key register command 134, byte 1 504 may indicate an extended status 266, bytes 2-5 506 may indicate key data 234, and bytes 6-37 508 may indicate a signature 236. The read data command, in response to the update HMAC key register command 134, may be associated with the HMAC message 302, where the HMAC message 302 may be based at least in part on the extended status 266 and the key data 234.

In some aspects, for a read data command in response to the write root key register command 132, byte 1 510 may indicate an extended status 266, bytes 2-13 512 may indicate a nonce 418, and bytes 14-45 514 may indicate a signature 224. The read data command, in response to the write root key register command 132, may be associated with the HMAC message 302, where the HMAC message 302 may be based at least in part on the extended status 266 and the nonce 418.

In some aspects, for a read data command in response to the increment MC command 138, byte 1 516 may indicate an extended status 266, bytes 2-13 518 may indicate a nonce 432, and bytes 14-45 520 may indicate a signature 260. The read data command, in response to the increment MC command 138, may be associated with the HMAC message 302, where the HMAC message 302 may be based at least in part on the extended status 266 and the nonce 432.

In an alternative approach, for a read data command in response to an update HMAC key register command, the read data command would only indicate an extended status and would not indicate key data. In the alternative approach, for a read data command in response to a write root key register command, the read data command would only indicate an extended status and would not indicate a nonce. In the alternative approach, for a read data command in response to an increment MC command, the read data command would only indicate an extended status and would not indicate a nonce. As a result, in the alternative approach, the read data command for the update HMAC key register command, the write root key register command, and the increment MC command would not provide any form of authentication. In other words, for RPMC commands other than the request MC command, no form of authentication was provided. As a result, an attacker would be able to interrupt a read data response for these types of RPMC commands and send false responses.

In some aspects, a read data command may indicate an extended status field, a tag field, a counter field, and a signature field, but the extended status field, the tag field, the counter field, and the signature field may only be valid when an issued command is a request MC command (e.g., request MC command 136, as shown in FIG. 1). When the issued command is the update HMAC key register command, the write root key register command, or the increment MC command, the tag field and the counter field may not be valid in a corresponding read data command. In other words, when the issued command is the update HMAC key register command, the write root key register command, or the increment MC command, the tag field and the counter field may be omitted or set to 0 in the corresponding read data command.

In some aspects, for RPMC commands 130 other than the request MC command, authentication may be provided by including the key data 234, the nonce 418, or the nonce 432, respectively, and by deriving HMAC messages 302 for signatures based at least in part on the key data 234, the nonce 418, or the nonce 432, respectively. For example, for the read data command in response to the update HMAC key register command 134, authentication may be achieved at least in part by incorporating the key data 234 and by deriving the HMAC message 302 for the signature 236 based at least in part on the key data 234. For the read data command in response to the write root key register command 132, authentication may be achieved at least in part by incorporating the nonce 418 and by deriving the HMAC message 302 for the signature 224 based at least in part on the nonce 418. For the read data command in response to the increment MC command 138, authentication may be achieved at least in part by incorporating the nonce 432 and by deriving the HMAC message 302 for the signature 260 based at least in part on the nonce 432.

As indicated above, FIG. 5 is provided as an example. Other examples may differ from what is described with regard to FIG. 5. The number and arrangement of devices shown in FIG. 5 are provided as an example. In practice, there may be additional devices, fewer devices, different devices, or differently arranged devices than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) shown in FIG. 5 may perform one or more functions described as being performed by another set of devices shown in FIG. 5.

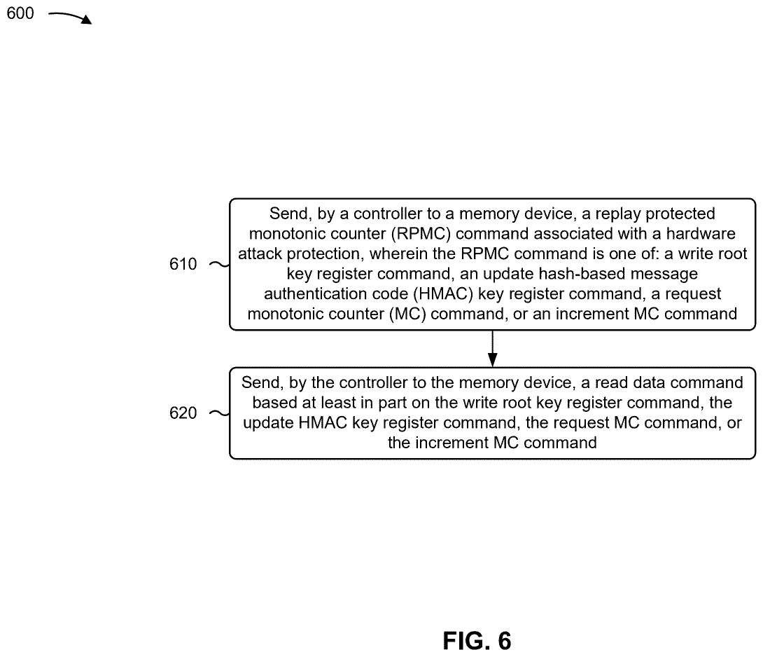

FIG. 6 is a flowchart of an example process 600 associated with sending RPMC commands. In some implementations, one or more process blocks of FIG. 6 are performed by a controller (e.g., controller 110). In some implementations, one or more process blocks of FIG. 6 are performed by another device or a group of devices separate from or including the controller.

As shown in FIG. 6, process 600 may include sending, to a memory device, an RPMC command associated with a hardware attack protection, wherein the RPMC command is one of: a write root key register command, an update HMAC key register command, a request MC command, or an increment MC command (block 610). For example, the controller may send, to a memory device, an RPMC command associated with a hardware attack protection, wherein the RPMC command is one of: a write root key register command, an update HMAC key register command, a request MC command, or an increment MC command, as described above.

As further shown in FIG. 6, process 600 may include sending, to the memory device, a read data command based at least in part on the write root key register command, the update HMAC key register command, the request MC command, or the increment MC command (block 620). For example, the controller may send, to the memory device, a read data command based at least in part on the write root key register command, the update HMAC key register command, the request MC command, or the increment MC command, as described above.

Process 600 may include additional implementations, such as any single implementation or any combination of implementations described below and/or in connection with one or more other processes described elsewhere herein.

In a first implementation, the read data command indicates an extended status, a tag, counter data, and a signature, and the signature is computed based at least in part on the extended status, the tag, and the counter data.

In a second implementation, alone or in combination with the first implementation, the extended status is authenticated in the read data command based at least in part on an HMAC message for the signature, and the HMAC message for the signature is based at least in part on the extended status, the tag, and the counter data.

In a third implementation, alone or in combination with one or more of the first and second implementations, the write root key register command indicates a command type, a counter address, a reserved byte, a nonce, a root key, and a signature.

In a fourth implementation, alone or in combination with one or more of the first through third implementations, the increment MC command indicates a command type, a counter address, a reserved byte, a nonce, counter data, and a signature.

In a fifth implementation, alone or in combination with one or more of the first through fourth implementations, the read data command is in response to the write root key register command, the read data command indicates an extended status, a nonce, and a signature, and the signature is based at least in part on the extended status and the nonce.

In a sixth implementation, alone or in combination with one or more of the first through fifth implementations, the read data command is in response to the update HMAC key register command, the read data command indicates an extended status, key data, and a signature, and the signature is based at least in part on the extended status and the key data.

In a seventh implementation, alone or in combination with one or more of the first through sixth implementations, the read data command is in response to the increment MC command, the read data command indicates an extended status, a nonce, and a signature, and the signature is based at least in part on the extended status and the nonce.

In an eighth implementation, alone or in combination with one or more of the first through seventh implementations, the controller is a serial flash controller, and the memory device is a serial flash device.

In a ninth implementation, alone or in combination with one or more of the first through eighth implementations, the controller and the memory device are in accordance with a JEDEC standard.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The following provides an overview of some Aspects of the present disclosure:
Aspect 1: A controller, comprising: one or more components configured to: send, to a memory device, a replay protected monotonic counter (RPMC) command associated with a hardware attack protection, wherein the RPMC command is one of: a write root key register command, an update hash-based message authentication code (HMAC) key register command, a request monotonic counter (MC) command, or an increment MC command; and send, to the memory device, a read data command based at least in part on the write root key register command, the update HMAC key register command, the request MC command, or the increment MC command.
Aspect 2: The controller of Aspect 1, wherein the read data command indicates an extended status, a tag, counter data, and a signature, and wherein the signature is computed based at least in part on the extended status, the tag, and the counter data.
Aspect 3: The controller of Aspect 2, wherein the extended status is authenticated in the read data command based at least in part on an HMAC message for the signature, and wherein the HMAC message for the signature is based at least in part on the extended status, the tag, and the counter data.
Aspect 4: The controller of any of Aspects 1-3, wherein the write root key register command indicates a command type, a counter address, a reserved byte, a nonce, a root key, and a signature.
Aspect 5: The controller of any of Aspects 1-4, wherein the increment MC command indicates a command type, a counter address, a reserved byte, a nonce, counter data, and a signature.
Aspect 6: The controller of any of Aspects 1-5, wherein the read data command is in response to the write root key register command, wherein the read data command indicates an extended status, a nonce, and a signature, and wherein the signature is based at least in part on the extended status and the nonce.
Aspect 7: The controller of any of Aspects 1-6, wherein the read data command is in response to the update HMAC key register command, wherein the read data command indicates an extended status, key data, and a signature, and wherein the signature is based at least in part on the extended status and the key data.
Aspect 8: The controller of any of Aspects 1-7, wherein the read data command is in response to the increment MC command, wherein the read data command indicates an extended status, a nonce, and a signature, and wherein the signature is based at least in part on the extended status and the nonce.
Aspect 9: The controller of any of Aspects 1-8, wherein the controller is a serial flash controller, and wherein the memory device is a serial flash device.
Aspect 10: The controller of any of Aspects 1-9, wherein the controller and the memory device are in accordance with a JEDEC memory standard.
Aspect 11: A method, comprising: sending, by a controller to a memory device, a replay protected monotonic counter (RPMC) command associated with a hardware attack protection, wherein the RPMC command is one of: a write root key register command, an update hash-based message authentication code (HMAC) key register command, a request monotonic counter (MC) command, or an increment MC command; and sending, by the controller to the memory device, a read data command based at least in part on the write root key register command, the update HMAC key register command, the request MC command, or the increment MC command.
Aspect 12: The method of Aspect 11, wherein the read data command indicates an extended status, a tag, counter data, and a signature, and wherein the signature is computed based at least in part on the extended status, the tag, and the counter data.
Aspect 13: The method of any of Aspects 11-12, wherein the write root key register command indicates a command type, a counter address, a reserved byte, a nonce, a root key, and a signature.
Aspect 14: The method of any of Aspects 11-13, wherein the increment MC command indicates a command type, a counter address, a reserved byte, a nonce, counter data, and a signature.
Aspect 15: The method of any of Aspects 11-14, wherein the read data command is in response to the write root key register command, wherein the read data command indicates an extended status, a nonce, and a signature, and wherein the signature is based at least in part on the extended status and the nonce.
Aspect 16: The method of any of Aspects 11-15, wherein the read data command is in response to the update HMAC key register command, wherein the read data command indicates an extended status, key data, and a signature, and wherein the signature is based at least in part on the extended status and the key data.
Aspect 17: The method of any of Aspects 11-16, wherein the read data command is in response to the increment MC command, wherein the read data command indicates an extended status, a nonce, and a signature, and wherein the signature is based at least in part on the extended status and the nonce.
Aspect 18: The method of any of Aspects 11-17, wherein the controller is a serial flash controller, and wherein the memory device is a serial flash device.
Aspect 19: The method of any of Aspects 11-18, wherein the controller and the memory device are in accordance with a JEDEC memory standard.
Aspect 20: A method, comprising: receiving, by a memory device from a controller, a replay protected monotonic counter (RPMC) command associated with a hardware attack protection, wherein the RPMC command is one of: a write root key register command, an update hash-based message authentication code (HMAC) key register command, a request monotonic counter (MC) command, or an increment MC command; and receiving, by the memory device from the controller, a read data command based at least in part on the write root key register command, the update HMAC key register command, the request MC command, or the increment MC command.
Aspect 21: A system configured to perform one or more operations recited in one or more of Aspects 1-20.
Aspect 22: An apparatus comprising means for performing one or more operations recited in one or more of Aspects 1-20.
Aspect 23: A non-transitory computer-readable medium storing a set of instructions, the set of instructions comprising one or more instructions that, when executed by a device, cause the device to perform one or more operations recited in one or more of Aspects 1-20.
Aspect 24: A computer program product comprising instructions or code for executing one or more operations recited in one or more of Aspects 1-20.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A controller, comprising:
one or more components configured to:
send, to a memory device, a replay protected monotonic counter (RPMC) command associated with a hardware attack protection, wherein the RPMC command is one of: a write root key register command, an update hash-based message authentication code (HMAC) key register command, a request monotonic counter (MC) command, or an increment MC command; and
send, to the memory device, a read data command based at least in part on the write root key register command, the update HMAC key register command, the request MC command, or the increment MC command.

2. The controller of claim 1, wherein the read data command indicates an extended status, a tag, counter data, and a signature, and wherein the signature is computed based at least in part on the extended status, the tag, and the counter data.

3. The controller of claim 2, wherein the extended status is authenticated in the read data command based at least in part on an HMAC message for the signature, and wherein the HMAC message for the signature is based at least in part on the extended status, the tag, and the counter data.

4. The controller of claim 1, wherein the write root key register command indicates a command type, a counter address, a reserved byte, a nonce, a root key, and a signature.

5. The controller of claim 1, wherein the increment MC command indicates a command type, a counter address, a reserved byte, a nonce, counter data, and a signature.

6. The controller of claim 1, wherein the read data command is in response to the write root key register command, wherein the read data command indicates an extended status, a nonce, and a signature, and wherein the signature is based at least in part on the extended status and the nonce.

7. The controller of claim 1, wherein the read data command is in response to the update HMAC key register command, wherein the read data command indicates an extended status, key data, and a signature, and wherein the signature is based at least in part on the extended status and the key data.

8. The controller of claim 1, wherein the read data command is in response to the increment MC command, wherein the read data command indicates an extended status, a nonce, and a signature, and wherein the signature is based at least in part on the extended status and the nonce.

9. The controller of claim 1, wherein the controller is a serial flash controller, and wherein the memory device is a serial flash device.

10. The controller of claim 1, wherein the controller and the memory device are in accordance with a JEDEC memory standard.

11. A method, comprising:
sending, by a controller to a memory device, a replay protected monotonic counter (RPMC) command associated with a hardware attack protection, wherein the RPMC command is one of: a write root key register command, an update hash-based message authentication code (HMAC) key register command, a request monotonic counter (MC) command, or an increment MC command; and
sending, by the controller to the memory device, a read data command based at least in part on the write root key register command, the update HMAC key register command, the request MC command, or the increment MC command.

12. The method of claim 11, wherein the read data command indicates an extended status, a tag, counter data, and a signature, and wherein the signature is computed based at least in part on the extended status, the tag, and the counter data.

13. The method of claim 11, wherein the write root key register command indicates a command type, a counter address, a reserved byte, a nonce, a root key, and a signature.

14. The method of claim 11, wherein the increment MC command indicates a command type, a counter address, a reserved byte, a nonce, counter data, and a signature.

15. The method of claim 11, wherein the read data command is in response to the write root key register command, wherein the read data command indicates an extended status, a nonce, and a signature, and wherein the signature is based at least in part on the extended status and the nonce.

16. The method of claim 11, wherein the read data command is in response to the update HMAC key register command, wherein the read data command indicates an extended status, key data, and a signature, and wherein the signature is based at least in part on the extended status and the key data.

17. The method of claim 11, wherein the read data command is in response to the increment MC command, wherein the read data command indicates an extended status, a nonce, and a signature, and wherein the signature is based at least in part on the extended status and the nonce.

18. The method of claim 11, wherein the controller is a serial flash controller, and wherein the memory device is a serial flash device.

19. The method of claim 11, wherein the controller and the memory device are in accordance with a JEDEC memory standard.

20. A method, comprising:
receiving, by a memory device from a controller, a replay protected monotonic counter (RPMC) command associated with a hardware attack protection, wherein the RPMC command is one of: a write root key register command, an update hash-based message authentication code (HMAC) key register command, a request monotonic counter (MC) command, or an increment MC command; and
receiving, by the memory device from the controller, a read data command based at least in part on the write root key register command, the update HMAC key register command, the request MC command, or the increment MC command.
